(19) United States
(12) Patent Application Publication
(10) Pub. No.: US 2025/0039616 A1
(43) Pub. Date: Jan. 30, 2025

(54) HEARING DEVICE AND RELATED METHOD OF WIRELESS CHARGING

(71) Applicant: GN Hearing A/S, Ballerup (DK)

(72) Inventors: Kim RASMUSSEN, Ballerup (DK); Klaus Hagen JENSEN, Copenhagen (DK); Lasse Emil Holmegaard Korff, Ballerup (DK)

(73) Assignee: GN Hearing A/S, Ballerup (DK)

(21) Appl. No.: 18/909,933

(22) Filed: Oct. 8, 2024

Related U.S. Application Data
(63) Continuation-in-part of application No. 18/636,059, filed on Apr. 15, 2024.
Application No. 18/636,059 is a continuation of application No. 17/540,941, filed on Dec. 2, 2021, now Pat. No. 12,047,748.

(30) Foreign Application Priority Data
Dec. 16, 2020 (DK) PA202070842

(51) Int. Cl. H04R 25/00; H02J 7/00; H02J 50/12

(52) U.S. Cl. CPC H04R 25/554; H02J 7/0044; H02J 50/12; H04R 25/30; H04R 2225/31

(57) ABSTRACT

A hearing device configured to be worn at an ear of a user, includes: an interface configured for communication with a charging device; a power module comprising a charging controller; and a temperature sensor configured to provide temperature data; wherein the charging controller is configured to: obtain the temperature data as a first charging parameter indicative of a temperature associated with the hearing device, and determine a primary charging scheme for charging a battery for the hearing device; wherein the charging controller is configured to determine the primary charging scheme based on the first charging parameter; and wherein the interface is configured to transmit

### RELATED APPLICATION DATA

This application is a continuation-in-part of U.S. patent application Ser. No. 18/636,059 filed on Apr. 15,2024, pending, which is a continuation of U.S. patent application Ser. No. 17/540,941 filed on Dec. 2, 2021, now U.S. Pat. No. 12,047,748, which claims priority to, and the benefit of, Danish Patent Application No. PA202070842 filed on Dec. 16, 2020. The entire disclosures of the above applications are expressly incorporated by reference herein.

### FIELD

The present disclosure relates to a hearing device and related methods including a method for charging of a hearing device. Further, a charging device for a hearing device is disclosed.

### BACKGROUND

In the field of hearing devices, charging of a hearing device entails challenges for the hearing device users, especially those currently being operated by a user. For example, charging of a hearing device can cause excessive energy output to the hearing device under certain conditions. This excessive energy output can lead to damage to the hearing device, certain components of the hearing device, and/or a user of the hearing device.

### SUMMARY

Accordingly, there is a need for devices and methods with improved charging of a hearing device.

A hearing device, e.g., configured to be worn at, in or on an ear of a user, is disclosed. The hearing device can comprise an interface. The interface can comprise a wireless transceiver. The wireless transceiver can be configured for wireless communication, e.g. with a charging device. The hearing device can comprise a power module. The power module can comprise a charging controller. The power module can comprise a receiving coil for wireless charging of a battery. The battery may be positioned in the hearing device. The charging controller can be configured to obtain a first charging parameter. The charging controller can be configured to determine a primary charging scheme, e.g. based on the first charging parameter. The charging controller can be configured to transmit a primary charging indicator, e.g. indicative of the primary charging scheme, via the interface, such as the wireless transceiver.

Further, a method of charging a hearing device comprising an interface comprising a wireless transceiver configured for wireless communication with a charging device, and a power module comprising a charging controller and a receiving coil for wireless charging of a battery positioned in the hearing device is disclosed. The method can comprise obtaining a first charging parameter, e.g. with the charging controller. The method can comprise determining a primary charging scheme, e.g. with the charging controller. The primary charging scheme can be based on the first charging parameter. The method can comprise transmitting a primary charging indicator, e.g. via the interface, such as the wireless transmitter. The primary charging indicator can be indicative of the primary charging scheme via the wireless transceiver.

Also, a charging device for charging of a hearing device is disclosed, the charging device comprising an interface comprising a wireless transceiver configured for wireless communication with a hearing device; and a power module comprising a charging controller and a transmitting coil for wireless transfer of power to a receiving coil of the hearing device. The charging controller of the charging device is configured to apply a default charging scheme in the power module; receive a primary charging indicator from the hearing device via the wireless transceiver; determine if the primary charging indicator is indicative of a change in charging scheme; in accordance with a determination that the primary charging indicator is indicative of a change in charging scheme, select a primary charging scheme based on the primary charging indicator; and apply the primary charging scheme in the power module.

The present disclosure provides a hearing device with improved charging capabilities. The present disclosure allows a hearing device to send control data through a data connection between the hearing device and a charger to regulate an amount of energy delivered to the hearing device.

For example, excess amounts of energy to the hearing device can be regulated and/or reduced and/or avoided. This can prevent damage to the hearing device and/or a user of the hearing device. For example, during wireless charging the hearing device may overheat due to the Tx side (charger) providing an excessive amount of energy and the excess being dissipated in regulator(s), etc., inside the electronics of the hearing device. This could force replacement of components of the hearing device, or the entire hearing device itself.

The improved charging capability results in improved usage of the hearing device, e.g., providing longer lifespans to the hearing device by avoiding overheating. Further, the present disclosure allows for simplification of hearing device charging which allows for more hearing aid models to be used with the same charger (e.g., less need for tight mechanical fits to connectors).

In other words, by controlling and/or regulating the charging capabilities of a hearing device, hearing device longevity and usability can be increased.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a schematic block diagram of an exemplary hearing device,

FIG. 2 is a schematic block diagram of an exemplary charging device,

FIG. 3 is a flow diagram of an exemplary method according to the disclosure, and

FIG. 4 illustrates charging schemes based on temperature thresholds according to an embodiment of the disclosure.

FIG. 5A illustrates other charging schemes based on temperature thresholds.

FIG. 5B illustrates other charging schemes based on a mode of a hearing device.

FIG. 5C illustrates charging schemes based on battery voltages.

FIG. 6 illustrates a logic diagram for implementing charging schemes that are based on battery voltage and temperature.

FIG. 7 illustrates a block diagram of charging components of a hearing device and a charging device.

FIG. 8 illustrates another block diagram of charging components of a hearing device and a charging device.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The hearing device is configured to be worn at, on or in an ear of a user. The hearing device may be arranged at the user's ear, on the user's ear, in the user's ear, in the user's ear canal, behind the user's ear, and/or in the user's concha, i.e., the hearing device is configured to be worn in, on and/or at the user's ear.

The hearing device may be an ear bud, a hearing aid, a personal sound amplification product (PSAP), an over-the-counter (OTC) hearing device, a hearing protection device, a custom hearing device or another ear-wearable hearing device. Hearing devices can include both prescription devices and non-prescription devices.

The hearing device may be embodied in various housing styles/form factors. Some of these form factors are a Behind-the-Ear (BTE) hearing device, a Receiver-in-Canal (RIC) hearing device, a Receiver-in-Ear (RIE) hearing device, or a Microphone-and-Receiver-in-Ear (MaRIE) hearing device. These devices have in common that they may comprise a BTE component configured to be worn behind the ear of the user and an in the ear (ITE) component configured to be inserted partly or fully into the user's ear canal. Generally, the BTE component may comprise at least one input transducer, a power source, and a processing unit. The term BTE hearing device may refer to a hearing device where the receiver, i.e. the output transducer, is comprised in the BTE component and sound is guided to the ITE component via a sound tube connecting the BTE and ITE components, whereas the terms RIE, RIC, and MaRIE devices refers to hearing devices where the receiver is comprised in the ITE component, which is coupled to the BTE component via a connector cable or wire configured for transferring electric signals between the BTE and ITE components.

Some of these form factors are In-the-Ear (ITE) hearing device, Completely-in-Canal (CIC) hearing device, or Invisible-in-Canal (IIC) hearing device. These hearing devices may comprise an ITE component, wherein the ITE component may comprises at least one input transducer, a power source, a processing unit, and an output transducer. These form factors may be custom devices, meaning that the ITE component may comprises a housing having a shell made from a hard material, such as a hard polymer or metal, or a soft material such as a rubber-like polymer, molded to have an outer shape conforming to the shape of the specific user's ear canal.

Some of these form factors are cochlear implant comprising a BTE component and an implant component. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

The hearing device may be configured for wireless communication with, e.g. reception of wireless signals from and/or transmission of wireless signals, such as control signals, to one or more devices, such as with another hearing device, e.g. as part of a binaural hearing system, and/or with one or more accessory devices, such as a smartphone and/or a charging device and/or a smart watch. The hearing device optionally comprises an antenna for converting one or more wireless input signals, e.g. a first wireless input signal and/or a second wireless input signal, to antenna output signal(s). The wireless input signal(s) may origin from external source(s), such as spouse microphone device(s), wireless TV audio transmitter, and/or a distributed microphone array associated with a wireless transmitter. The wireless input signal(s) may origin from another hearing device, e.g. as part of a binaural hearing system, and/or from one or more accessory devices.

The hearing device optionally comprises a wireless transceiver or radio transceiver e.g. also denoted or forming part of magnetic induction unit, coupled to the antenna (e.g. as part of the magnetic induction unit) for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device may comprise a plurality of antennas and/or an antenna may be configured to be operate in one or a plurality of antenna modes. The transceiver input signal optionally comprises a first transceiver input signal representative of the first wireless signal from a first external source.

The hearing device optionally comprises a set of microphones. The set of microphones may comprise one or more microphones. The set of microphones comprises a first microphone for provision of a first microphone input signal and/or a second microphone for provision of a second microphone input signal. The set of microphones may comprise N microphones for provision of N microphone signals, wherein N is an integer in the range from 1 to 10. In one or more exemplary hearing devices, the number N of microphones is two, three, four, five or more. The set of microphones may comprise a third microphone for provision of a third microphone input signal. The set of microphones may provide one or more input signals to the processing unit. The processing unit may process input signal(s) from the one or more microphones and/or optionally a radio transceiver. The processing unit may provide an output signal to a receiver, such as an output transducer, for conversion to an audio output signal.

The hearing device comprises a processing unit for processing input signals, such as (optionally pre-processed) transceiver input signal(s) from magnetic induction unit and/or (optionally pre-processed) microphone input signal(s) from the microphone(s). The processing unit is optionally configured to compensate for hearing loss of a user of the hearing device. The processing unit provides an electrical output signal based on the input signals to the processing unit.

The hearing device may comprise a first housing and optionally a second housing. A housing, such as the first housing and/or the second housing, may be configured to accommodate one or more of the processing unit, a main power source (battery), a first power supply, a magnetic induction unit, and a second power supply. The hearing device may be of the in-the-ear (ITE) type or in-the-canal (ITC) type and comprise a first housing configured as an in-the-ear housing to be worn in or at the ear canal of a user. As an alternative the hearing device may comprise a first housing optionally configured as a behind-the-ear housing to be worn behind the pinna of a user and optionally a second housing optionally configured as an earpiece housing to be worn in or at the ear canal of a user. A wire may connect the first housing and the second housing.

In one or more example hearing devices, the hearing device is configured to be worn at, in, or on an ear of a user, the hearing device comprising: an interface comprising a wireless transceiver configured for wireless communication with a charging device; a power module comprising a charging controller and a receiving coil for wireless charging of a battery positioned in the hearing device; and a temperature sensor configured to provide temperature data indicative of a temperature in the hearing device, wherein the charging controller is configured to obtain the temperature data as a first charging parameter indicative of a temperature in the hearing device; determine a primary charging scheme based on the first charging parameter; and transmit a primary charging indicator indicative of the primary charging scheme via the wireless transceiver.

The hearing device comprises a main power source, such as a battery. The main power source may comprise a power output terminal for providing electrical power to electrical components of the hearing device, such as one or more of a processing unit, magnetic induction unit, and power module. The main power source may be positioned in the hearing device.

The main power source may comprise a power source, such as one or more batteries and/or battery packs. The main power source may comprise one or more power sources, such as one or more batteries, e.g. a battery pack comprising one or more batteries, such as one battery, two batteries, three batteries. The main power source may comprise one or more batteries, such as button cell batteries. At least some of the one or more batteries may comprise one or more of Lithium batteries, Nickel batteries, and/or Lead batteries. The battery/batteries may be air-activated. At least one of the main power source is a rechargeable battery, e.g. via power module of the hearing device. The main power source may be rechargeable via a connector of interface for connecting a power cable. The main power source may be rechargeable wirelessly.

One or more exemplary hearing devices can include particular methods and systems for charging the hearing device. In particular, one or more exemplary hearing devices, hearing devices can have configurations (e.g., systems, components) for requesting different charging schemes, for example having different energies, from one or more charging devices. These charging parameters can be based on parameters and/or indicators of the hearing device itself.

One or more exemplary hearing devices can include an interface having a wireless transceiver for wireless communication, as mentioned above. The wireless transceiver may be configured for wireless communication, e.g. in the 2.4 GHz band, with a charging device (e.g., apparatus, system, component). Thus, the hearing device, such as the power module, can request and/or control energy/charging power from a charging device in order to wirelessly charge a main power source/battery in the hearing device. The hearing device can then convert that energy to voltage and/or current as needed in the hearing device.

One or more exemplary hearing devices can include a power module. The power module can be used for charging of the main power source, such as a battery. The power module may be in electrical communication with the main power source. One or more exemplary hearing devices can include multiple power modules for multiple power sources. The power module may be in electrical communication with the interface, e.g. for feeding control parameters, such as charging indicator(s) including the first charging parameter, to the interface.

The power module can comprise a receiving coil. The receiving coil can receive a wireless signal, which can then be converted to electrical energy for powering and/or recharging the main power source/battery. Other charging methods can be used as well, and the particular power module with receiving coil is not limiting. Thus, the hearing device (for example, the main power source) may be wirelessly charged or charged by electrical contact from a charging device.

An example wireless charging system for wirelessly charging the hearing device is Qi, which is a standardized wireless charging system. Alternative charging systems can be used as well. For example, radiofrequency charging, electromagnetic induction, magnetic (e.g., optionally magnetic resonance), electric field coupling, and/or radio reception can all be used for charging the hearing device.

Further, the power module may include a charging controller (e.g., system, accessory, device, component, programming). The charging controller can control and/or request different levels of energy output from a charging device, e.g. by transmitting charging indicator(s), such as primary charging indicator via the wireless transmitter. The charging controller can change an energy output request to a charging device. The charging controller can request a stop of energy from the charging device. The charging controller can request an increase and/or decrease of energy from a charging device. Thus, the charging controller can control or modify the amount of energy sent from the charging device to the hearing device, preventing, for example, overheating or damage to the hearing device.

The charging controller may be configured to obtain a first charging parameter. The first charging parameter can be indicative of a particular state, characteristic, level (e.g., battery level or charge level or temperature level), and/or operating parameter of the hearing device and/or one or more components of the hearing device. In one or more exemplary hearing devices, the first charging parameter can be indicative of temperature of the hearing device, and the hearing device may include a temperature sensor (e.g., detector). In one or more exemplary hearing devices, the first charging parameter can be indicative of a voltage over the receiving coil, and the hearing device may include a voltage detector. In one or more exemplary hearing devices, the first charging parameter can be indicative of a current over the receiving coil, and the hearing device may include a current detector. One or more exemplary hearing devices can have a temperature sensor and/or a voltage detector and/or a current detector optionally connected to the power module/charging controller.

As mentioned, in one or more implementations the first charging parameter can be indicative of a temperature of the hearing device. For example, the hearing device, such as the power module, can include a temperature sensor configured to provide temperature data as the first charging parameter to the charging controller. In one or more exemplary hearing devices, the first charging parameter can be indicative of pressure, humidity, motion, height, and/or other physical characteristics of the hearing device and/or one or more components of the hearing device. Thus, the hearing device can include one or more sensors indicative of or sensing one or more physical characteristics of the hearing device. The one or more sensors may be connected to the power module/charging controller.

The temperature sensor may be configured to measure a temperature, such as a temperature of the hearing device, e.g. at temperature of at least one of the power module, the charging controller, the receiving coil, and the battery. In other words, the temperature data may be indicative of a temperature of at least one of the power module, the charging controller, the receiving coil, and the battery.

In one or more exemplary hearing devices, the charging controller is configured to obtain one or more, such as a plurality of, charging parameters including the first charging parameter and optionally one or more of a second charging parameter, a third charging parameter, etc. The second charging parameter and/or third charging parameter can be indicative of pressure, humidity, motion, height, and/or other physical characteristics of the hearing device and/or one or more components of the hearing device. Thus, the hearing device can include one or more sensors indicative of one or more physical characteristics of the hearing device. In certain implementations, the second charging parameter can be indicative of a battery level, such as a battery voltage, of the hearing device. In alternative embodiments, the first charging parameter can be indicative of a voltage over the receiving coil, and the hearing device may include a voltage detector. In alternative embodiments, the first charging parameter can be indicative of a current over the receiving coil, and the hearing device may include a current detector.

The charging controller can be configured to determine a primary charging scheme based on the first charging parameter. In one or more exemplary hearing devices, the charging controller can determine a charging scheme, such as the primary charging scheme and/or a secondary charging scheme, based on a secondary charging parameter. In one or more exemplary hearing devices, the charging controller can determine the primary charging scheme based on one or more, such as a plurality of, charging parameters, such as a first charging parameter and a second charging parameter.

The primary charging scheme may define, be representative or indicative of a particular energy output level requested from a charging device. Thus, in one or more exemplary hearing devices, the charging controller can be configured to determine a desired energy receipt from a charging device based on the first charging parameter. For example, the charging controller can be configured to determine a desired energy receipt from a charging device based on a temperature of the hearing device.

The primary charging scheme may be selected from a set (e.g., group, list, collection) of charging schemes. The set of charging schemes can include a set of different charging schemes, e.g. each representative of a different energy output level request. The charging schemes may be pre-made or pre-defined charging schemes having different associated energy output level requests. The charging schemes may alternatively be computed by a processor based on charging parameter(s), such as the first charging parameter.

In one or more exemplary hearing devices, the set of charging schemes can include a normal charging scheme, wherein normal operating energy, leading to normal operating current and voltage, is requested from the charging device. In one or more exemplary hearing devices, the set of charging schemes can also include an off (e.g., no power) charging scheme, wherein no energy is requested from the charging device.

In one or more exemplary hearing devices, the set of charging schemes can include a reduced energy charging scheme, wherein reduced energy, energy between 0 and normal, such as about 50% of normal or default, is requested from the charging device. This can lead to reduced voltage and/or reduced current to provide a less aggressive charging which reduces the wear and/or stress on the components of the hearing device. In one or more exemplary hearing devices, the set of charging schemes can include an increased energy charging scheme, wherein increased energy, energy above normal, is requested from the charging device. This can lead to increased voltage and/or increased current in turn reducing the charging time and providing a more aggressive charging of the hearing device.

In one or more exemplary hearing devices, the set of charging schemes can further include a reduced current charging scheme, wherein a current between the normal operating current and no current is requested from the charging device. In one or more exemplary hearing devices, the group of charging schemes can further include a reduced voltage charging scheme, wherein a voltage between the normal operating voltage and no current is requested from the charging device.

In one or more exemplary hearing devices, the group of charging schemes can further include an increased voltage charging scheme, wherein a voltage above the normal operating voltage is requested from the charging device. In one or more exemplary hearing devices, the group of charging schemes can further include an increased current charging scheme, wherein a current above the normal operating current is requested from the charging device.

Other charging schemes can be used as well, and the particular charging scheme is not limiting. Further, the primary charging scheme may be a particular voltage and/or current level to be requested from a charging device.

Thus, based on the first charging parameter, one of the above charging schemes can be determined based on the first charging parameter. In turn, based on the first charging parameter a particular energy output can be requested from the charging device.

In one or more exemplary hearing devices, the charging controller can transmit a primary charging indicator. The primary charging indicator can be indicative of the primary charging scheme, e.g. as selected from a set of charging schemes. For example, the primary charging indicator can be indicative of one of the above-discussed charging schemes. The charging controller can transmit the primary charging indicator via a wireless transceiver, e.g. in the 2.4 GHz band. The wireless transceiver can, for example, wirelessly communicate with one or more charging devices. In one or more exemplary hearing devices, the primary charging indicator can include a request for a particular energy level (e.g., the primary charging scheme) from a charging device.

Thus, the charging device would provide the requested energy output of the primary charging scheme. The primary charging indicator may be data or datum, flags, or other indicators. For example, the primary charging indicator may comprise one or more bits, such as multiple bits. The charging indicator may a byte or less than a byte.

The primary charging indicator can be indicative of a charging power and/or a duty cycle of the primary charging scheme. The primary charging indicator can be indicative of a charging power of the primary charging scheme. The primary charging indicator can be indicative of a duty cycle of the primary charging scheme. In certain implementations, the primary charging indicator may be indicative of a reduction or increase (e.g., a change) of a charging power and/or a duty cycle of the primary charging scheme.

In one or more exemplary hearing devices, and as discussed below, based on the received primary charging indicator, the charging device could output an energy level based on the primary charging scheme that the primary charging indicator is indicative of. For example, if the primary charging scheme was a normal charging scheme, the charging device could output a normal energy level to provide a normal level of voltage and current to the hearing aid. If the primary charging scheme was an off-charging (or no charge) scheme, the charging device would not output any energy to the hearing device. Further, the primary charging indicator may indicate a change of a charging scheme. For example, from a normal energy scheme to a reduced energy scheme. The primary charging indicator may not cause any change within the charging device in certain situations where there is no need to change energy output.

In one or more exemplary hearing devices, the determining of the charging controller of a primary charging scheme based on the first charging parameter may involve certain criteria, specifically one or more criteria. For example, the determining can determine if a first charging criterion based on the first charging parameter is satisfied. In accordance with the first charging criterion being satisfied (e.g., if the first charging criterion is satisfied), the charging controller can be configured to select a first charging scheme with associated first charging indicator as the primary charging scheme. The selection of the first charging scheme can be from a set of charging schemes as the primary charging scheme, such as discussed above.

The first charging criterion may be, for example, a temperature criterion. Thus, the first charging criterion can be satisfied if a temperature of the hearing device, such as from a temperature sensor, is larger than a first threshold or is in a first range. Further, the first charging criterion can be satisfied if the temperature is below a second threshold. In some implementations, the first charging criterion can be satisfied if a temperature of the hearing device is between the first threshold and the second threshold. If the first charging criterion is satisfied with the temperature being larger than a first threshold and/or less than a second threshold, the first charging scheme can have a reduced charging power. If the first charging criterion is satisfied with the temperature being larger than a first threshold and/or less than a second threshold, the first charging scheme can have a reduced voltage. If the first charging criterion is satisfied with the temperature being larger than a first threshold and/or less than a second threshold, the first charging scheme can have a reduced current.

In some implementations, the first charging criterion can be made up of a number of different threshold ranges. For example, the first charging criterion could have a first threshold range, a second threshold range, a third threshold range, a fourth threshold range, and/or a fifth threshold range. Thus, the first charging parameter could be within one of the threshold ranges, and the primary charging scheme would be selected based on the particular threshold range.

As a non-limiting example, the first charging parameter could be a temperature value of the hearing device. The first charging criterion could be a number of temperature threshold ranges. These can include a “too cold” temperature threshold range, a “cool” temperature threshold range, a “normal” temperature threshold range, a “warm” temperature threshold range, and a “hot” temperature threshold range. The primary charging scheme may then vary depending on the particular temperature threshold range the first charging parameter is in.

For example, the primary charging scheme may be an off-charging scheme for too cold, a reduced current charging scheme with reduced current for cool, normal charging scheme for normal, a reduced voltage charging scheme for warm, and an off-charging scheme for hot.

In alternative implementations, the first charging criterion could be a normal temperature threshold range, and an abnormal temperature threshold range. The primary charging scheme may be a normal charging scheme, whereas the abnormal temperature range may not receive any current or voltage (e.g., be an off-charging scheme).

Example temperature threshold ranges can include below 0° C. (e.g., too cold), from 0-10° C. (e.g., cool), from 11-45° C. (e.g., normal), from 46-56° C. (e.g., warm), and from above 56° C. (e.g., hot). However, other temperature ranges can be used as well. For example, from 10° C. to 56° C. could be a normal temperature range, and a temperature outside would be abnormal.

As mentioned above, in certain implementations the charging controller can be configured to obtain a second charging parameter along with a first charging parameter. The charging controller can then determine a primary charging scheme bey determining if a second charging criterion based on the first charging parameter and/or the second charging parameter is satisfied. In accordance with the second charging criterion being satisfied (e.g., if the second charging criterion is satisfied), the charging controller can be configured to select a second charging scheme. The second charging scheme may be associated with a second charging indicator. The second charging scheme may be selected from a set of charging schemes as the primary charging scheme.

As an example, and mentioned above, the second charging parameter can be indicative of a battery level in the hearing device. The battery level can be a particular percentage of a total battery level. In certain implementations, the battery level can be particular intervals of a total battery level. For example, 5, 6, 7, 8, 9, or 10 intervals. A second charging criterion can be satisfied if a change in the battery level over time is less than a second threshold. If so, the second charging scheme has an increased charging power.

In one or more exemplary hearing devices, the primary charging scheme may be based on a current charging scheme. Thus, the primary charging scheme may not change any output of the charging device. In other words, the charging controller may determine a primary charging scheme based on a currently employed charging scheme, e.g. in order to prevent rapid changes in the charging voltage and/or current.

In one or more exemplary hearing device systems, a charging device for a hearing device is disclosed. The charging device can be used alone, or in conjunction with the one or more exemplary hearing devices and methods disclosed herein.

One or more exemplary charging devices can include an interface. The interface can include a wireless transceiver. The wireless transceiver can be configured for wireless communication, e.g. in the 2.4 GHz band, with a hearing device, such as a hearing device of the one or more exemplary hearing devices disclosed above.

One or more exemplary charging devices can include a power module. The power module may comprise a charging controller. The power module can include a transmitting coil. The transmitting coil can wirelessly transfer power externally. For example, the transmitting coil can transmit power to a receiving coil, such as a receiving coil of one or more exemplary hearing devices disclosed herein.

In one or more exemplary charging devices, the charging controller can be configured to apply a default charging or normal charging scheme in the power module. The default charging scheme can include outputting the normal energy scheme as discussed above. In alternative embodiments, the default charging scheme may be the current charging scheme, such as after the disclosed change to the primary charging scheme. Therefore, once the charging device has applied a primary charging scheme, this may be the new default charging scheme.

In one or more exemplary charging devices, the charging controller can further be configured to receive a primary charging indicator, such as from the hearing device. The charging controller can be configured to receive a primary charging indicator via the wireless transmitter.

In one or more exemplary charging devices, the charging controller can be configured to determine if the primary charging indicator would be indicative of a change in charging scheme. For example, it could be indicative of a change in charging scheme from the default charging scheme.

In accordance with a determination that the primary charging indicator is indicative of a change in charging scheme, the charging controller can be configured to select a primary charging scheme. This can be based on the primary charging indicator. The primary charging scheme may be one of the primary charging schemes discussed in detail above.

In one or more exemplary charging devices, the charging controller of the charging device can be configured to apply the primary charging scheme in the power module, e.g. according to the primary charging indicator received from the hearing device. Accordingly, the charging controller could output varying energy levels to one or more exemplary hearing devices.

In one or more exemplary hearing devices, the hearing device may have a particular method of charging.

In one or more exemplary methods, the hearing device may include an interface.

The interface may include a wireless transceiver. The wireless transceiver may be configured for wireless communication with a charging device, such as discussed above. The interface may further include a power module. The power module may include a charging controller. The power module may further include a receiving coil. The receiving coil may be used for wirelessly charging the main power source, which may include any or all of the power sources discussed above.

In one or more exemplary methods, the method can include obtaining a first charging parameter. The first charging parameter can be any or all of the first charging parameters discussed in detail above.

In one or more exemplary methods, the method can include determining a primary charging scheme. This may be based on the first charging parameter. The primary charging scheme may be any or all of the primary charging schemes discussed in detail above.

In one or more exemplary methods, the method can include transmitting a primary charge indicator. This may be transmitted to a charging device. The primary charge indicated may be indicative of the primary charging scheme. The transmitting may be performed via the wireless transceiver. The primary charge indicator may be any or all of the primary charging indicators discussed in detail above.

Advantageously, the one or more exemplary methods can allow for charging of the hearing device, while preserving longevity to the hearing device and preventing harm to the hearing device and/or a user of the hearing device. As discussed, the method can vary the request of energy levels from a charging device based on varying conditions of the hearing device. In one or more exemplary methods, the method can prevent overheating of a hearing device based on, for example, temperature of the hearing device. When the hearing device is outside of normal operating temperatures, the method can transmit a primary charging indicator indicative of a lessened current or voltage wirelessly to the charging device.

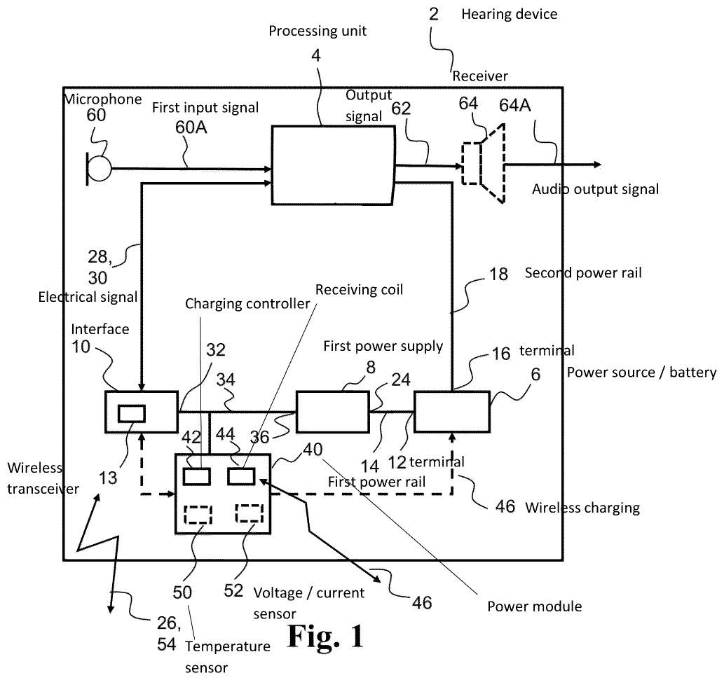

FIG. 1 schematically illustrates an exemplary hearing device. The hearing device 2 comprises a processing unit 4. The processing unit 4 may be configured to compensate for hearing loss. The hearing device 2 comprises a main power source (e.g., battery) 6, a first power supply 8, and an interface 10. The main power source 6 may comprise one or more power output terminals for providing electrical power to electrical components of the hearing device 2 via one or more power rails. For example, the main power source 6 comprises a first power output terminal 12 connected to a first power rail 14 for feeding a first voltage/power to one or more electrical components including the first power supply 8. The first power rail 14 may feed the processing unit 4. A second power output terminal 16 of the main power source 6 may be connected to a second power rail 18, e.g. for feeding a second voltage/power to the processing unit 4.

In one or more exemplary hearing devices, a second power output terminal (not shown) of the first power supply 8 may be connected to a second power rail 18, e.g. for feeding a second voltage/power to the processing unit 4.

The hearing device 2 comprises an interface 10 having a wireless transceiver 13 configured for reception and/or transmission of wireless signals including a first wireless signal 26, for example to a charging device. The first wireless signal 26 may comprise the primary charging indicator. The interface 10 may be configured to convert the first wireless signal 26 to an electrical signal 28 that is fed to the processing unit 4 and/or to convert an electrical signal 30 from the processing unit 4 to first wireless signal 8. The electrical signals 28, 30 may be data and/or control signals. The interface 10 comprises a power input terminal 32 for receiving power from the first power supply 8 via transceiver power rail 34.

The first power supply 8 optionally is a switch-mode power and is connected to the main power source/battery 6 for providing electrical power to one or more electrical components of the hearing device including the interface 10 and/or a power module 40. The first power supply 8 comprises a power input terminal 24 connected to the first power rail 14 for receiving power from the main power source 6. The first power supply 8 comprises a first power output terminal 36 for feeding power to the interface 10 and/or the power module via transceiver power rail 34. The power module 40 may be fed via second power rail 18.

The hearing device 2 comprises a power module 40. The power module 40 can include a charging controller 42 and a receiving coil 44. The receiving coil 44 may be used for wireless charging 46 of the main power source 6 via the receiving coil 44 and connection 48. In other words, the power module 40 receives wireless power 46 via receiving coil 44 and charges the main power source/battery 6 with power from the receiving coil 44 via connection 48.

The hearing device 2, such as power module 40, may comprise one or more sensors, such as temperature sensor 50 and/or voltage/current sensor or detector 52 for provision of sensor data. The sensors 50, 52 may be connected to the charging controller 42 for feeding sensor data/output, such as temperature and/or voltage/current, as charging parameters to the charging controller 42. In the illustrated hearing device, the sensors are included in the power module 40, however one or more sensors may be arranged in other components of the hearing device 2.

The charging controller 42 may be configured to obtain a first charging parameter, such as a temperature from temperature sensor 50, determine a primary charging scheme based on the first charging parameter, and transmit a primary charging indicator 54 indicative of the primary charging scheme via the wireless transceiver 13 via wireless connection 26. In one or more exemplary hearing devices, the primary charging indicator 54 indicative of the primary charging scheme may be transmitted via the receiving coil 44.

The hearing device 2 may comprise one or more microphones including microphone 60 for provision of one or more input signals including a first input signal 60A to the processing unit 4. The processing unit 4 processes input signal(s) including first input signal 60A from the microphone 60 and/or optionally electrical signal 28 from interface 10/wireless transceiver 13 and provides an output signal 62 to a receiver 64, such as an output transducer, for conversion of the output signal 62 to an audio output signal 64A.

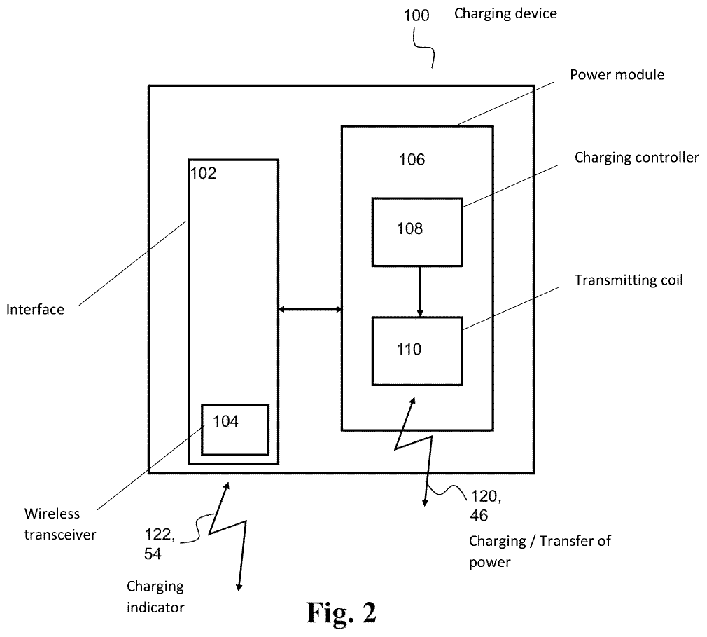

FIG. 2 schematically illustrates an exemplary charging device. The charging device 100 can be used to charge hearing device, such as hearing device 2 of FIG. 1.

The charging device 100 comprises an interface 102 which can include a wireless transceiver 104. The wireless transceiver 104 can be configured for wireless communication, e.g. in the 2.4 GHz band, such as with the hearing device 2 of FIG. 1.

The charging device 100 also comprises a power module 106 configured for wireless charging 46 of hearing devices. The power module 106 can comprise a charging controller 108 and a transmitting coil 110 for the wireless transfer of power 120, such as to a receiving coil of a hearing device like the hearing device 2 of FIG. 1.

The charging controller 108 is configured to receive charging indicators including primary charging indicator 54 via the wireless transceiver 104.

The charging controller 108 can be configured to apply a default charging scheme in the power module, receive a primary charging indicator 54 from the hearing device 2 via the wireless transceiver 104, determine if the primary charging indicator is indicative of a change in charging scheme, in accordance with a determination that the primary charging indicator is indicative of a change in charging scheme, select a primary charging scheme based on the primary charging indicator, and apply the primary charging scheme in the power module 106. To apply the primary charging scheme in the power module 106 may comprises to transmit wireless power with the transmitting coil according to the primary charging scheme, e.g. according to one or more of voltage and current applied to the transmitting coil.

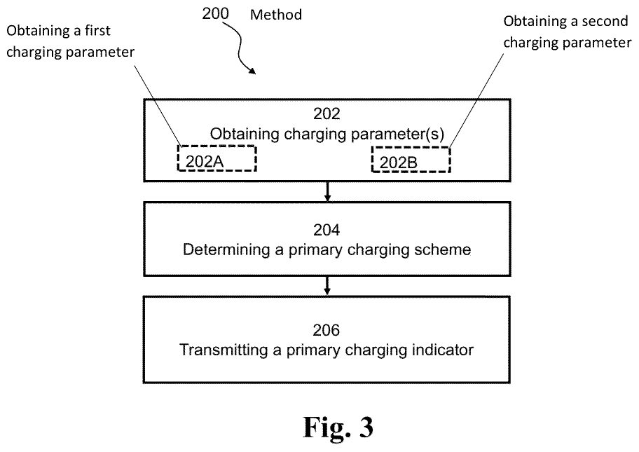

FIG. 3 is a flow diagram of an exemplary method according to the disclosure, such as a method 200 performed in a hearing device (such as the hearing device disclosed herein, such as the hearing device 2 of FIG. 1), for charging of a hearing device comprising an interface comprising a wireless transceiver configured for wireless communication with a charging device, and a power module comprising a charging controller and a receiving coil for wireless charging of a battery positioned in the hearing device. The method 200 comprises obtaining 202 one or more charging parameters. In other words, the method 200 comprises obtaining 202A a first charging parameter and optionally obtaining 202B a second charging parameter.

In one or more exemplary methods and/or hearing devices, the method 200 comprises determining 204 a primary charging scheme based on the first charging parameter and/or the second charging parameter.

In one or more exemplary methods and/or hearing devices, the method 200 comprises transmitting 206 a primary charging indicator indicative of the primary charging scheme via the wireless transceiver.

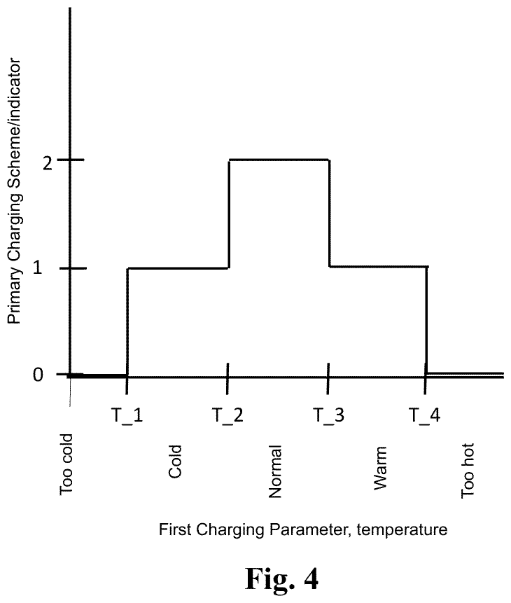

FIG. 4 is an illustration of an example of determining a primary charging scheme based on first charging parameter. As shown, the primary charging scheme can be based on first charging criterion, for example based on different temperature threshold ranges such as shown in FIG. 4.

The hearing device can determine a primary charging scheme based on the first charging parameter. For example, the primary charging scheme may vary in voltage or current from a normal voltage and current based on temperature, such as shown in FIG. 4.

In FIG. 4, a temperature T_HD (first charging parameter) less than T_1 (too cold) or larger than T_4 (too hot) is optionally mapped to an off-charging scheme, e.g. with the primary charging indicator being set to zero, such as “00” in a two-bit implementation of the charging indicator. In the off-charging scheme, no charging power is transmitted from the charging device. A temperature (first charging parameter) in the range from T_1 to T_2 (cold) or in the range from T_3 to T_4 (hot) may be mapped to an intermediate-charging scheme with reduced energy charging, e.g. with the primary charging indicator being set to one, such as “01” in a two-bit implementation of the charging indicator. A temperature (first charging parameter) in the range from T_2 to T_3 (normal) may be mapped to a normal-charging scheme or default charging scheme, e.g. with the primary charging indicator being set to two, such as “10” in a two-bit implementation of the charging indicator. In other words, a first charging criterion may be given as or at least based on:

T_HD<T_1 OR T_HD>T_4,

wherein the first charging scheme is an off-charging scheme. An exemplary value of T_1 is 0° C. and an exemplary value of T_4 is 56° C.

Further, a second charging criterion may be given as or at least based on:

T_2<T_HD<T_3

wherein the second charging scheme is a normal-charging scheme. An exemplary value of T_2 is 0° C. or 10° C. and an exemplary value of T_3 is 46° C. or 56° C. . . .

A third charging criterion may be given as or at least based on:

T_1=<T_HD=<T_2 or T_3=<T_HD=<T_4

wherein the third charging scheme is an intermediate-charging scheme, e.g. where the charging power is a reduced charging power compared to the normal or default charging power, such as a fraction e.g. in the range from 20 to 80% of the charging power in the normal-charging scheme.

In other words, the charging controller of the hearing device may be configured to determine if a third charging criterion based on the first charging parameter and/or the second charging parameter is satisfied, and in accordance with the third charging criterion being satisfied, select a third charging scheme with associated third charging indicator from a set of charging schemes as the primary charging scheme.

It should be noted that the charging scheme based on charging parameter(s) is not limited to the example shown in FIG. 4. For example, in other cases, the charging device 100 may provide a charging current as a function of temperature that is different from that shown in FIG. 4 (e.g., different from the profile shown in the figure).

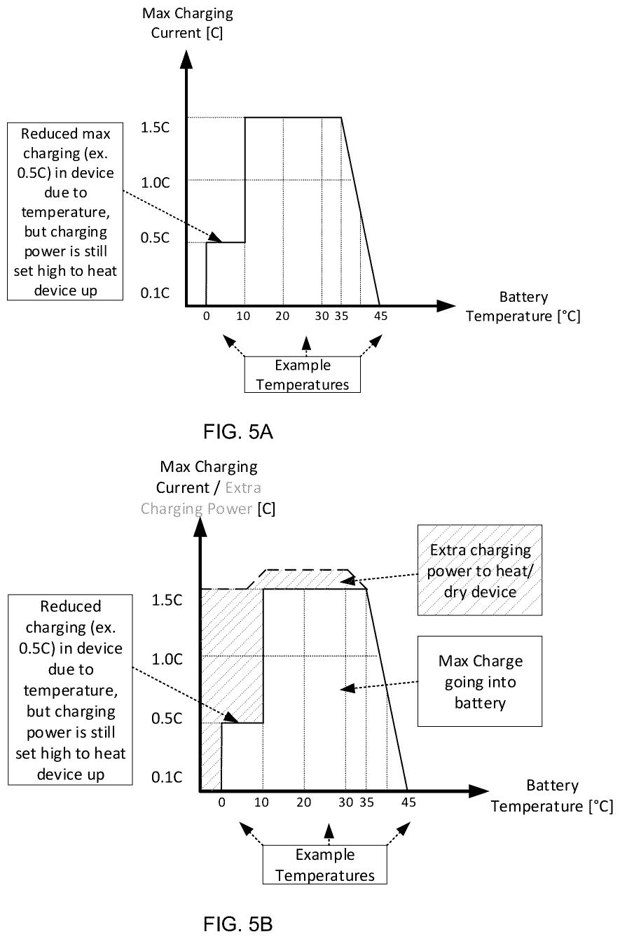

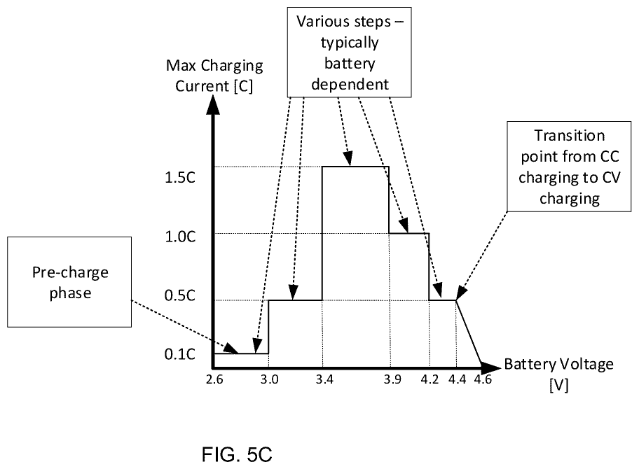

FIG. 5A illustrates other charging schemes based on temperature thresholds. In the figure, the charging current is given in “C”, which is a charging current as a function of battery size (e.g., 1 C current for charging a 18 mAh battery is 18 mA). As shown in the example, the charging device 100 is configured to provide a maximum charging current/power of 1.5 C in a first charging scheme if the temperature measured at the hearing device 2 is between 10° C. (example of first threshold) and 35° C. (example of second threshold). The charging device 100 is configured to provide a reduced charging current/power of 0.5 C in a second charging scheme if the temperature measured at the hearing device 2 is between 0° C. and 10° C. (example of first threshold). As shown in the illustrated example, when the temperature measured at the hearing device 2 is higher than 35° C. (example of second threshold)—e.g., between 35° C. and 45° C., the charging device 100 is configured to provide a continuously decreasing charging current/power in a third charging scheme as a function of increasing temperature above 35° C. (example of second threshold). This feature is advantageous because it allows the charging device 100 to gradually decrease the charging current/power after the temperature exceeds the second threshold (e.g., 35° C.). In other cases, instead of the continuously decreasing charging current/power, the charging device 100 may be configured to provide a charging current in the third charging scheme that decreases in two or more steps as a function of increasing temperature above the second threshold (e.g., 35° C.). Such feature will also allow the charging device 100 to gradually decrease the charging current/power after the temperature exceeds the second threshold (e.g., 35° C.).

In the illustrated example, the charging device 100 is configured to provide no charging current/power in a fourth charging scheme if the temperature measured at the hearing device 2 is below 0° C. (example of third threshold) or above 45° C. (example of fourth threshold).

In other cases, instead of, or in addition to, the continuous change or the multiple-steps change in the charging current/power for the temperature range above the second threshold (e.g., above 35° C.), the charging device may provide continuous change or multiple-steps change in the charging current/power for the temperature range below the first threshold (e.g., below 10° C.). In particular, when the temperature measured at the hearing device 2 is lower than 10° C. (example of first threshold)-e.g., between 0° C. and 10° C., the charging device 100 is configured to provide a continuously decreasing charging current/power in the second charging scheme as a function of decreasing temperature below 10° C. (example of first threshold). This feature is advantageous because it allows the charging device 100 to gradually decrease the charging current/power when the temperature falls below the first threshold (e.g., 10° C.). In other cases, instead of the continuously decreasing charging current/power, the charging device 100 may be configured to provide a charging current in the second charging scheme that decreases in two or more steps as a function of decreasing temperature below the first threshold (e.g., 10° C.). Such feature will also allow the charging device 100 to gradually decrease the charging current/power after the temperature falls below the first threshold (e.g., 10° C.).

In some cases, the charging scheme may be based on a mode of the hearing device 2. For example, in some cases, the hearing device 2 may be in a drying mode. In such cases, the charging parameter may be a mode indicator indicating that the hearing device is in the drying mode, and the hearing device 2 may be configured to determine the primary charging scheme as a drying-charging scheme. The hearing device 2 may transmit a charging indicator (e.g., primary charging indicator) indicating that the hearing device is in a drying mode and/or that the primary charging scheme is a drying-charging scheme. In the drying-charging scheme, the charging device 100 is configured to provide charging current/power that is higher than that when the hearing device 2 is in its normal operation mode.

In some cases, the hearing device 2 may optionally include a moisture sensor configured to detect moisture in the hearing device 2. In such cases, the drying mode may be entered automatically in response to a detected moisture detected by the moisture sensor. In other cases, after the moisture sensor detects the moisture, the processing unit in the hearing device 2 may generate a control signal to cause a feedback to be provided to inform the user that moisture has been detected. For example, the processing unit may operate a speaker of the hearing device 2 to an audio feedback (e.g., beep, message, etc.) informing the user of the detected moisture, may operate a display or a LED of the hearing device 2 to provide visual feedback informing the user of the detected moisture, may operate a vibration component to generate a vibration to inform the user of the detected moisture, or two or more of the foregoing. In further cases, the hearing device 2 may transmit a signal to an accessory device (e.g., cell phone, laptop, computer, tablet (e.g., ipad), smart watch, etc.), informing the accessory device that moisture has been detected. The accessory device may then provide audio feedback, visual feedback, vibration feedback, or two or more of the foregoing, to inform the user that moisture has been detected. After the user is informed of the detected moisture, the user may operate a user interface at the hearing device 2 (such as a button, a switch, etc.) or a user interface (e.g., a graphical user interface, which may be provided by an application installed in the accessory device) at the accessory device, to place the hearing device 2 in the drying mode.

In other cases, the hearing device 2 may not include any moisture sensor. In such cases, if the user knows or suspects that moisture has entered into the hearing device 2, the user may operate the user interface at the hearing device 2 (such as a button, a switch, etc.) or the user interface at the accessory device, to place the hearing device 2 in the drying mode.

FIG. 5B illustrates exemplary charging schemes based on a mode of the hearing device 2. As shown in the example, if the mode of the hearing device 2 is a drying mode, and the measured temperature at the hearing device 2 is below the first threshold (e.g., 10° C.), then the charging device 100 provides a charging current of 1.5 C (as opposed to 0.5 C in the normal operation mode for that temperature range) in order to raise the temperature of the hearing device to reduce or eliminate the moisture. If the mode of the hearing device 2 is a drying mode, and the measured temperature at the hearing device 2 is between the first threshold (e.g., 10° C.) and the second threshold (e.g., 35° C.), then the charging device 100 may provide a charging current that is higher than 1.5 C (e.g., 1.8 C, 2.0 C, etc.), as opposed to 1.5 C in the normal operation mode for that temperature range, in order to raise the temperature of the hearing device 2 to reduce or eliminate the moisture. As shown in the figure, if the hearing device is in the drying mode, and the measured temperature at the hearing device 2 is above the second threshold (e.g., 35° C.), then the charging device 100 provides the same charging scheme as that of the normal operation mode—e.g., the charging current decreases continuously as a function of increasing measured temperature exceeding the second threshold (e.g., 35° C.). This is because, when the hearing device 2 is already having high temperature, then no additional heating from the charging is needed to reduce or eliminate the moisture. Alternatively, the charging scheme for temperature exceeding the second threshold when the hearing device 2 is in the drying mode may involve providing charging current that is higher than that of the normal operation mode.

Thus, in some cases, if power for normal mode of charging is P0 (e.g., 0.5 C), a higher power P1>P0 (e.g., 1.0 C, 1.5 C, etc.) may be employed for the charging, wherein the additional power may cause dissipated heat to heat up and/or dry the hearing device (e.g., interior of the hearing device), and/or may cause a more rapid charging combined with dissipated heat. In other words, the charging can intentionally be made less efficient in order to, for instance, to heat up the hearing device and/or to dry the hearing device.

In some cases, the hearing device 2 may be in a warm-up mode. This may occur automatically when the measured temperature at the hearing device (e.g., battery) is below the first threshold (e.g., 10° C.). As shown in FIG. 5B, if the hearing device 2 is in the warm-up mode, then the charging current may be increased to 1.5 C in order to warm-up the hearing device. Alternatively, the charging of the battery may remain at 0.50, but the transferred power increased to 1.5 C, resulting in extra dissipated heat and/or less efficient charging. This may heat up the device for drying purpose.

In some cases, the charging current/power provided by the charging device 100 may be based on the measured temperature at the hearing device 2 and/or a mode of the hearing device 2. Accordingly, a charging scheme may be based on the measured temperature at the hearing device 2 and/or a mode of the hearing device 2.

In some cases, a charging scheme may be based on a battery voltage in combination with (1) measured temperature at the hearing device 2 and/or (2) a mode of the hearing device 2. FIG. 5C illustrates charging schemes based on battery voltages. The charging device 100 is configured to provide charging current that depends on a voltage of the battery. Providing a charging scheme based on battery voltage is advantageous because it can optimize the charging (e.g., charge as fast as possible) and/or reduce impact of aging or degradation of the battery. In the illustrated example, the charging current provided by the charging device 100 in the various charging schemes varies from 0 C to 1.5 C, depending on the voltage of the battery of the hearing device 2. In particular, the charging current is 0.1 C when the battery voltage is below 3V, the charging current is 0.5 C when the battery voltage is between 3.0V and 3.4V, the charging current is 1.5 C when the battery voltage is between 3.4V and 3.9V, the charging current is 1.0 C when the battery voltage is between 3.9V and 4.2V, the charging current is 0.5 C when the battery voltage is between 4.2V and 4.4V, and the charging current decreases as a function of battery voltage when the battery voltage is above 4.4V. The transition point is 4.4V in the example, but it may have other values in other cases. Such transition point may be battery dependent, charger dependent, design dependent, or any combination of the foregoing.

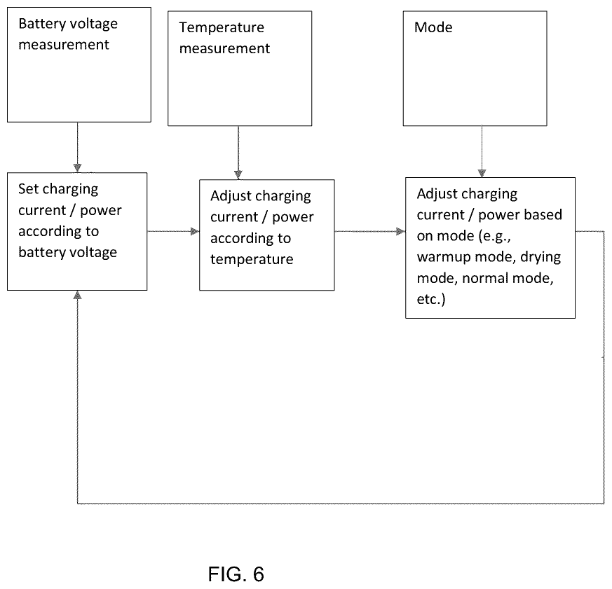

FIG. 6 illustrates a logic diagram for implementing charging schemes that are based on battery voltage and temperature. In some cases, the logic diagram may be used to combine the charging schemes of FIG. 4/5A and FIG. 5C, and also optionally FIG. 5B. As shown in the figure, the battery voltage is measured (e.g., by a voltage sensor at the hearing device 2), and the charging device 100 (or the hearing device 2) may then determine and set the charging current/power based on the measured battery voltage. In some cases, the setting of the charging current/power based on battery voltage may be based on the scheme shown in FIG. 5C. The temperature at the hearing device 2 is also measured (e.g., by a temperature sensor at the hearing device 2), and the charging device 100 (or the hearing device 2) may then determine and set/adjust the charging current/power based on the measured temperature. In some cases, the charging current/power based on the measured temperature may be based on the scheme shown in FIG. 4 or 5A.

Also, as shown in FIG. 6, in some cases, a mode of the hearing device 2 may be determined, and the charging device 100 (or the hearing device 2) may then determine and set/adjust the charging current/power based on the mode of the hearing device 2. By means of non-limiting examples, the mode of the hearing device 2 may be a normal mode, a warmup mode, a drying mode, etc. In some cases, the charging current/power based on the mode may be based on the scheme shown in FIG. 5B.

Although FIGS. 5A-5C illustrate examples of different charging schemes, it should be noted that the charging scheme is not limited to these examples. In other cases, the charging scheme may have temperature thresholds that are different from the 0° C., 10° C., 35° C., 45° C. shown in the examples. Also, in other cases, the number of temperature threshold(s) may be one, two, three, four, five, six, or more than six. Similarly, in other cases, the charging scheme may have battery voltage thresholds that are different from the 3V, 3.4V, 3.9V, 4.2V, 4.6V shown in the example of FIG. 5C. In some cases, the number of battery voltage threshold(s) may be one, two, three, four, five, six, or more than six. Furthermore, in other cases, the charging current(s) may be different from the 0.1 C, 0.5 C, 1.0 C, 1.5 C, 0.5 C shown in the examples.

In some cases, to combine the battery voltage dependent charging scheme of FIG. 5C with the temperature dependent charging scheme of FIG. 5A, the diagrams of these figures may be combined or linked with each other logically. For example, the two diagrams may be superimposed, and the lower value of (1) the charging current/power for the relevant temperature range obtained from FIG. 5A and (2) the charging current/power for the relevant battery voltage obtained from FIG. 5C, is then utilized for the charging. In other cases, the charging current/power in one of the diagrams may be expressed as a function of the charging current/power in the other one of the diagrams.

Another way to integrate the two logically may be to utilize the scheme of FIG. 5A to limit the capability of the scheme of FIG. 5C, and vice versa. For instance, if the measured temperature is in the temperature range 0° C. to 10° C., the charging is limited to 0.5 C based on FIG. 5A. Accordingly, if the battery voltage is between 3.4V and 3.9V, the charging current will still be set 0.5 C, even though the charging current is set at 1.5 C based on FIG. 5C (i.e., the lower value of 0.5 C from FIG. 5A, and 1.5 C from FIG. 5C, is selected in the example). On the other hand, if the measured temperature is between 10° C. and 35° C., then the charging current may be set at 1.5 C based on FIG. 5A. In such cases, the limiting factor will be the voltages in FIG. 5C in certain situations. For example, if the battery voltage is between 3V and 3.4V, the charging will be 0.5 C (not 1.5 C based on FIG. 5A—because the lower value of 0.5 C from FIG. 5C and 1.5 C from FIG. 5A is selected). As another example, if the battery voltage is between 3.9V and 4.2V, the charging will be 1.0 C (not 1.5 C based on FIG. 5A—because the lower value of 1.0 C from FIG. 5C and 1.5 C from FIG. 5A is selected).

The battery voltage measurement and the temperature measurement may be performed concurrently with each other. Alternatively, the battery voltage measurement and the temperature measurement may be performed sequentially, e.g., one after the other, such as in an alternating manner. Also, the battery voltage measurement may be performed continuously, or periodically. Similarly, the temperature measurement may be performed continuously, or periodically. In some cases, the battery voltage measurement and the temperature measurement may be performed at different respective frequencies.

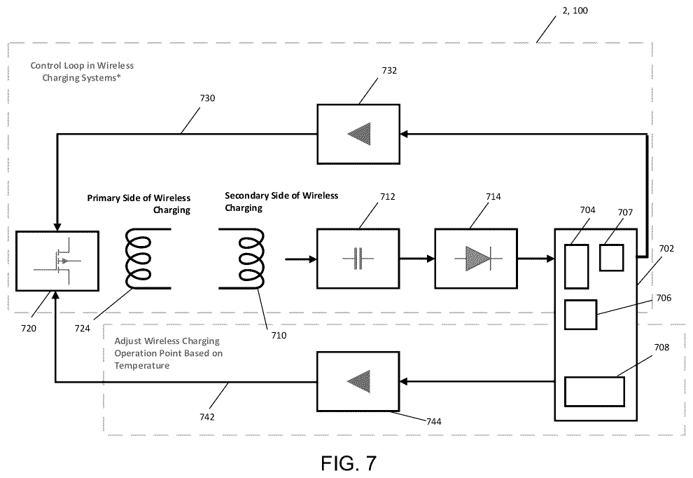

FIG. 7 illustrates a block diagram of charging components of the hearing device 2 and the charging device 100. In the illustrated example, the charging device 100 is configured to provide wireless charging to charge the battery of the hearing device 2. As shown in the figure, the hearing device 2 includes a processing unit 702. The processing unit 702 may include a hearing device charging circuit 704 and a battery 706. The hearing device charging circuit 704 may include a power module comprising a charging controller, as described herein. The hearing device 2 also includes a receiving coil 710 configured to receiving charging energy from the charging device 100. The hearing device 2 also includes a circuit 712 (e.g., resonance circuit, or any of other types of circuit) and a rectifier 714. The resonance circuit 712 is configured to boost the charging voltage or energy to enhance a coupling in the magnetic link between the receiving coil 710 and a transmitting coil 724 of the charging device 100. The rectifier 714 is coupled between the resonance circuit 712 and the battery. The rectifier is configured to transform AC voltage to DC voltage. The charging device 100 includes charger circuit 720 and the transmitting coil 724 configured to provide charging energy for charging the battery 706 of the hearing device 2.

The hearing device 2 also includes a temperature sensor 708 configured to sense a temperature at the hearing device 2. The temperature sensor 708 may be configured to sense a temperature of the battery, an ambient temperature inside the hearing device 2, or a temperature of another component in the hearing device 2.

The hearing device 2 includes an interface 707 configured to communicate (wirelessly or non-wirelessly) one or more parameters with the charging device 100, wherein a parameter may represent one or more characteristics associated with an operation of the hearing device 2, or may be a charging scheme indicator indicating a charging scheme. By means of non-limiting examples, the parameter may represent a battery voltage, a battery charge level, a temperature measured at the hearing device 2, an operation mode of the hearing device 2, etc., or may indicate a charging scheme determined based on one or more of the foregoing. The interface 707 may be a wireless communication interface, in which case, the hearing device 2 may include an antenna for transmitting one or more parameters from the hearing device 2 to the charging device 100. Alternatively, the interface 707 may be a wired communication interface, in which case, the hearing device 2 is configured to communicate with the charging device 100 via one or more wires for transmitting one or more parameters from the hearing device 2 to the charging device 100. In further cases, the interface 707 may include multiple channels (e.g., wireless channels, wired channels such as wires, or both wireless channel(s) and wired channel(s)) for communicating respective parameters from the hearing device 2 to the charging device 100. For example, one channel may be configured to communicate a first parameter associated with a battery voltage of the battery 706, and another channel may be configured to communicate a second parameter associated with a measured temperature at the hearing device 2.

The hearing device 2 is configured to communicate with the charging device 100 to implement one or more feedback loop(s), such as first feedback loop 730 and/or second feedback loop 742. In the illustrated example, the first feedback loop 730 is configured to transmit (from the hearing device 2 to the charging device 100), via the interface 707, a parameter associated with a battery voltage of the battery 706 at the hearing device 2. For examples, such parameter may be a battery voltage, or may indicate a battery voltage, or may be a charging scheme indicator determined based on the battery voltage. The second feedback loop 742 is configured to transmit (from the hearing device 2 to the charging device 100), via the interface 707, a parameter associated with a measured temperature at the hearing device 2. For examples, such parameter may be a measured temperature, or may indicate a measured temperature, or may be a charging scheme indicator determined based on the measured temperature. In further cases, there may be a third feedback loop configured to transmit (from the hearing device 2 to the charging device 100), via the interface 707, a parameter associated with an operation mode of the hearing device 2. For examples, such parameter may be a mode indicator indicating a drying mode of the hearing device 2, a warm-up mode of the hearing device 2, or a normal operation mode of the hearing device 2.

In some cases, the first feedback loop 730 and the second feedback loop 742 may be combined (e.g., logically combined), and may be implemented as a single feedback loop. If the system has the third feedback loop, then all three feedback loops may be combined (e.g., logically combined) and may be implemented as a single feedback loop.

The system shown in FIG. 7 also includes a first logic module 732 and a second logic module 744. The first logic module 732 is configured to determine a charging scheme, or a charging voltage/power based on a battery voltage of the battery 706 at the hearing device 2. The second logic module 744 is configured to determine a charging scheme, or a charging voltage/power based on the sensed temperature from the temperature sensor 708 at the hearing device 2. In some cases, the first logic module 732 and the second logic module 744 may be configured to form a single logic module, which determines a charging scheme, or a charging voltage/power based on the battery voltage of the battery 706 and/or based on the sensed temperature measured by the temperature sensor 708. The first logic module 732 may be implemented at the hearing device 2, at the charging device 100, or at both the hearing device 2 and the charging device 100 (e.g., a part of the first logic module 732 may be at the hearing device 2, and another part of the first logic module 732 may be at the charging device 100). Similarly, the second logic module 744 may be implemented at the hearing device 2, at the charging device 100, or at both the hearing device 2 and the charging device 100 (e.g., a part of the second logic module 744 may be at the hearing device 2, and another part of the second logic module 744 may be at the charging device 100). If the first and second logic modules 732, 744 are combined into one logic module, then such module may be implemented at the hearing device 2, at the charging device 100, or at both the hearing device 2 and the charging device 100 (e.g., a part of the logic module may be at the hearing device 2, and another part of the logic module may be at the charging device 100).

The first logic module 732 and the second logic module 744 may be implemented using hardware, software, or a combination of both. In some cases, a part or an entirety of the first logic module 732, and/or a part or an entirety of the second logic module 744, may be implemented in the hearing device charging circuit 704 (e.g., may be a part of a power module comprising a charging controller). Also, in some cases, the first and second logic modules 732, 744 may be integrated, and may be implemented using one or more transfer function(s) that (1) obtains the voltage, the historic voltage, the temperature, and the historic temperature, and (2) sets a charging scheme to adjust a setting (e.g., power, voltage, current) for the charging device 100.

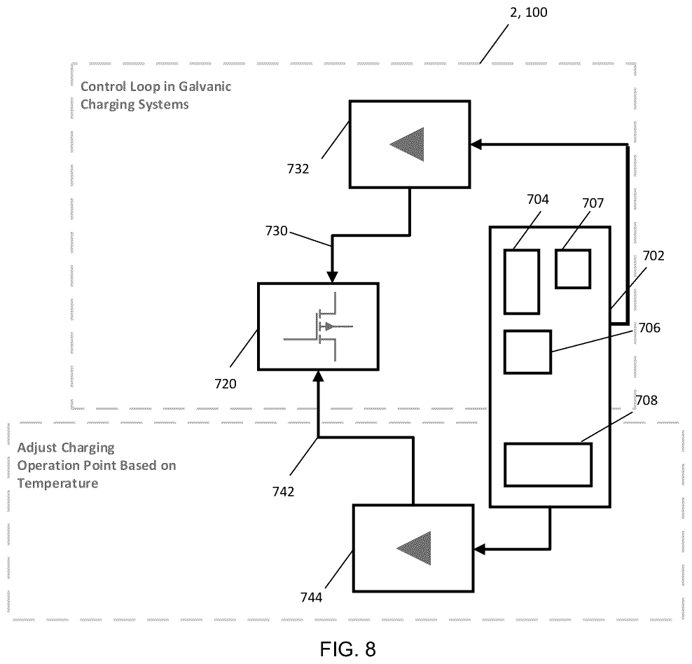

FIG. 8 illustrates another block diagram of charging components of the hearing device 2 and the charging device 100. In the illustrated example, the charging device 100 is configured to provide non-wireless charging to charge the battery of the hearing device 2. The system shown in FIG. 8 is the same as that in FIG. 7, except that it does not include the transmitting coil 724 and the receiving coil 710. The system of FIG. 8 is based on galvanic charging. The charging scheme described previously with reference to FIGS. 5A-5C for wireless charging is also applicable for the galvanic charging.

In some cases, the logic (e.g., implemented by the first logic module 732 and/or second logic module 744) for determining the charging current/power may be implemented in the hearing device 2. In such cases, after the charging current/power is determined in the hearing device 2, the hearing device 2 then communicates with the charging device 100 (wirelessly or non-wirelessly) to inform the charging device 100 of the determined charging current/power that is to be achieved. The charging device 100 then adjust the charging current/power accordingly. In other cases, the logic (e.g., implemented by the first logic module 732 and/or second logic module 744) for determining the charging current/power may be implemented in the charging device 100. In such cases, the hearing device 2 may communicate one or more parameters with the charging device 100 (wirelessly or non-wirelessly), such as a measured temperature at the hearing device 2, a battery voltage, a mode of the hearing device 2, etc., or any combination of the foregoing. After the charging device 100 obtains the parameter(s), the charging device 100 then set the charging current/power based on the parameter(s) in accordance with a charging scheme. In further cases, the logic (e.g., implemented by the first logic module 732 and/or second logic module 744) for determining the charging current/power may be implemented in both the hearing device 2 and the charging device 100.

Also disclosed are hearing device, methods, and charging device according to any of the following items.

Item 1. A hearing device configured to be worn at an ear of a user, the hearing device comprising:
an interface configured for communication with a charging device;
a power module comprising a charging controller; and
a temperature sensor configured to provide temperature data;
wherein the charging controller is configured to: obtain the temperature data as a first charging parameter indicative of a temperature associated with the hearing device, and determine a primary charging scheme for charging a battery for the hearing device;
wherein the charging controller is configured to determine the primary charging scheme based on the first charging parameter; and
wherein the interface is configured to transmit a primary charging indicator indicative of the primary charging scheme.

Item 2. The hearing device according to item 1, wherein the primary charging indicator is indicative of a charging power and/or a duty cycle.

Item 3. The hearing device according to item 1, wherein the charging controller is configured to determine whether a first criterion is satisfied based on the first charging parameter, and in accordance with the first criterion being satisfied, select a first charging scheme from a set of charging schemes as the primary charging scheme.

Item 4. The hearing device according to item 3, wherein the first charging scheme is associated with a first charging indicator.

Item 5. The hearing device according to item 3, wherein the charging controller is configured to determine the first criterion as being satisfied if the temperature is larger than a first threshold and/or less than a second threshold.

Item 6. The hearing device according to item 3, wherein the first charging scheme has a reduced charging power compared to a current charging scheme.

Item 7. The hearing device according to item 3, wherein the charging controller is configured to determine whether a second criterion is satisfied based on the first charging parameter and/or a second charging parameter.

Item 8. The hearing device according to item 7, wherein the second charging parameter is indicative of a battery level.

Item 9. The hearing device according to item 7, wherein the charging controller is configured to determine the second criterion as being satisfied if a change in a battery level over time is less than a threshold.

Item 10. The hearing device according to item 7, wherein the charging controller is configured to select a second charging scheme from the set of charging schemes as the primary charging scheme if the second criterion is satisfied.

Item 11. The hearing device according to item 10, wherein the second charging scheme has an increased charging power compared to a current charging scheme.

Item 12. The hearing device according to item 1, wherein the charging controller is configured to obtain a second charging parameter.

Item 13. The hearing device according to item 12, wherein the second charging parameter is indicative of a battery level.

Item 14. The hearing device according to item 1, wherein the primary charging scheme is based on a current charging scheme.

Item 15. The hearing device according to item 1, wherein the primary charging indicator comprises multiple bits.

Item 16. The hearing device according to item 1, wherein the temperature associated with the hearing device is a temperature in the hearing device.

Item 17. The hearing device according to item 1, further comprising a circuit and a rectifier, wherein the rectifier is coupled between the resonance circuit and the battery.

Item 18. The hearing device according to item 1, wherein the charging

controller is configured to select a drying-charging scheme as the primary charging scheme when the hearing device is in a drying mode.

Item 19. The hearing device according to item 1, wherein the charging controller is configured to select a warm-up-charging scheme as the primary charging scheme when the hearing device is in a warm-up mode.

Item 20. The hearing device according to item 1, wherein the charging controller is configured to:
select a first charging scheme as the primary charging scheme if the temperature is above a first threshold and below a second threshold,
select a second charging scheme as the primary charging scheme if the temperature is below the first threshold, and
select a third charging scheme as the primary charging scheme if the temperature is above the second threshold.

Item 21. The hearing device according to item 20, wherein a first charging current associated with the first charging scheme is larger than a second charging current associated with the second charging scheme, and is larger than a third charging current associated with the third charging scheme.

Item 22. The hearing device according to item 20, wherein in the third charging scheme, a charging current decreases continuously as a function of increasing temperature above the second threshold.

Item 23. The hearing device according to item 20, wherein in the third charging scheme, a charging current decreases in two or more steps as a function of increasing temperature above the second threshold.

Item 24. A hearing device configured to be worn at an ear of a user, the hearing device comprising:
an interface configured for communication with a charging device; and
a power module comprising a charging controller;
wherein the charging controller is configured to select a drying-charging scheme for charging a battery for the hearing device when the hearing device is in a drying mode,
wherein in the drying-charging scheme, a charging current is increased to cause the hearing device to heat up for drying the hearing device; and
wherein the interface is configured to transmit a charging indicator indicative of the drying-charging scheme.

Item 25. A method of charging a hearing device comprising an interface for communication with a charging device, and a power module comprising a charging controller, the charging device configured to charge a battery in the hearing device, wherein the method comprises:
obtaining a first charging parameter;
determining a primary charging scheme based on the first charging parameter; and
communicating, using the interface of the hearing device, a primary charging indicator indicative of the primary charging scheme to the charging device.

Item 26. A charging device for charging of a hearing device, the charging device comprising:
an interface for communication with a hearing device; and
a power module comprising a charging controller;
wherein the charging controller is configured to: apply a default charging scheme in the power module; receive a primary charging indicator from the hearing device via the interface; determine if the primary charging indicator is indicative of a change in charging scheme; in accordance with a determination that the primary charging indicator is indicative of a change in charging scheme, select a primary charging scheme based on the primary charging indicator; and apply the primary charging scheme in the power module.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that FIGS. 1-3 comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in the order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

2 hearing device
4 processing unit
6 main power source, battery
8 first power supply
10 interface
12 first power output terminal of main power source
13 wireless transceiver
14 first power rail
16 second power output terminal of main power source
18 second power rail
24 power input terminal of first power supply
26 first wireless signal, wireless connection
28 electrical signal to the processing unit
30 electrical signal to the interface
32 power input terminal of interface
34 transceiver power rail
36 power output terminal of first power supply
40 power module
42 charging controller
44 receiving coil
46 wireless charging
48 connection
50 temperature sensor
52 voltage/current sensor
54 primary charging indicator, charging indicator(s)
60 microphone
60A first input signal
62 output signal
64 receiver
64A audio output signal
100 charging device
102 interface
104 wireless transceiver
106 power module
108 charging controller
110 transmitting coil
120 wireless transfer of power
122 receive a primary charging indicator
200 method for power supply management of a hearing device
202 obtaining charging parameter(s)
202A obtaining a first charging parameter
202B obtaining a second charging parameter
204 determining a primary charging parameter
206 transmitting a primary charging indicator
702 processing unit
704 hearing device charging circuit
706 battery
707 interface
708 temperature sensor
710 receiving coil
712 circuit
714 rectifier
720 charger circuit
724 transmitting coil
730 first feedback loop
732 first logic module
742 second feedback loop
744 second logic module

1. A hearing device configured to be worn at an ear of a user, the hearing device comprising:
an interface configured for communication with a charging device;
a power module comprising a charging controller; and
a temperature sensor configured to provide temperature data;
wherein the charging controller is configured to: obtain the temperature data as a first charging parameter indicative of a temperature associated with the hearing device, and determine a primary charging scheme for charging a battery for the hearing device;
wherein the charging controller is configured to determine the primary charging scheme based on the first charging parameter; and
wherein the interface is configured to transmit a primary charging indicator indicative of the primary charging scheme.

2. The hearing device according to claim 1, wherein the primary charging indicator is indicative of a charging power and/or a duty cycle.

3. The hearing device according to claim 1, wherein the charging controller is configured to determine whether a first criterion is satisfied based on the first charging parameter, and in accordance with the first criterion being satisfied, select a first charging scheme from a set of charging schemes as the primary charging scheme.

4. The hearing device according to claim 3, wherein the first charging scheme is associated with a first charging indicator.

5. The hearing device according to claim 3, wherein the charging controller is configured to determine the first criterion as being satisfied if the temperature is larger than a first threshold and/or less than a second threshold.

6. The hearing device according to claim 3, wherein the first charging scheme has a reduced charging power compared to a current charging scheme.

7. The hearing device according to claim 3, wherein the charging controller is configured to determine whether a second criterion is satisfied based on the first charging parameter and/or a second charging parameter.

8. The hearing device according to claim 7, wherein the second charging parameter is indicative of a battery level.

9. The hearing device according to claim 7, wherein the charging controller is configured to determine the second criterion as being satisfied if a change in a battery level over time is less than a threshold.

10. The hearing device according to claim 7, wherein the charging controller is configured to select a second charging scheme from the set of charging schemes as the primary charging scheme if the second criterion is satisfied.

11. The hearing device according to claim 10, wherein the second charging scheme has an increased charging power compared to a current charging scheme.

12. The hearing device according to claim 1, wherein the charging controller is configured to obtain a second charging parameter.

13. The hearing device according to claim 12, wherein the second charging parameter is indicative of a battery level.

14. The hearing device according to claim 1, wherein the primary charging scheme is based on a current charging scheme.

15. The hearing device according to claim 1, wherein the primary charging indicator comprises multiple bits.

16. The hearing device according to claim 1, wherein the temperature associated with the hearing device is a temperature in the hearing device.

17. The hearing device according to claim 1, further comprising a circuit and a rectifier, wherein the rectifier is coupled between the resonance circuit and the battery.

18. The hearing device according to claim 1, wherein the charging controller is configured to select a drying-charging scheme as the primary charging scheme when the hearing device is in a drying mode.

19. The hearing device according to claim 1, wherein the charging controller is configured to select a warm-up-charging scheme as the primary charging scheme when the hearing device is in a warm-up mode.

20. The hearing device according to claim 1, wherein the charging controller is configured to:
select a first charging scheme as the primary charging scheme if the temperature is above a first threshold and below a second threshold,
select a second charging scheme as the primary charging scheme if the temperature is below the first threshold, and
select a third charging scheme as the primary charging scheme if the temperature is above the second threshold.

21. The hearing device according to claim 20, wherein a first charging current associated with the first charging scheme is larger than a second charging current associated with the second charging scheme, and is larger than a third charging current associated with the third charging scheme.

22. The hearing device according to claim 20, wherein in the third charging scheme, a charging current decreases continuously as a function of increasing temperature above the second threshold.

23. The hearing device according to claim 20, wherein in the third charging scheme, a charging current decreases in two or more steps as a function of increasing temperature above the second threshold.

24. A hearing device configured to be worn at an ear of a user, the hearing device comprising:
an interface configured for communication with a charging device; and
a power module comprising a charging controller;
wherein the charging controller is configured to select a drying-charging scheme for charging a battery for the hearing device when the hearing device is in a drying mode,
wherein in the drying-charging scheme, a charging current is increased to cause the hearing device to heat up for drying the hearing device; and
wherein the interface is configured to transmit a charging indicator indicative of the drying-charging scheme.
